(19) United States
(12) Patent Application Publication
(10) Pub. No.: US 2023/0413833 A1
(43) Pub. Date: Dec. 28, 2023

(54) METHOD FOR PROCESSING AND BATCHING FOOD ITEMS

(71) Applicants: MAREL INC., Seattle, WA (US); MAREL POULTRY B.V., Boxmeer (NL)

(72) Inventors: Haraldur HARALDSSON, Seattle, WA (US); Jan-Pieter FEDDEMA, Boxmeer (NL)

(21) Appl. No.: 18/253,670

(22) PCT Filed: Nov. 22, 2021
(86) PCT No.: PCT/EP2021/082493

§ 371 Date: May 19, 2023

(30) Foreign Application Priority Data
Nov. 24, 2020 (EP) 20209582.4

(51) Int. Cl. A22C 21/00; A22C 17/00; G05B 19/4155

(52) U.S. Cl. CPC A22C 21/0053; A22C 17/002; G05B 19/4155; G05B 2219/45047

(57) ABSTRACT

A method of fulfilling a plurality of weight batch orders in a food item processing line, including: obtaining an estimated weight data of a first supply batch of food items; receiving a plurality of weight batch orders; allocating a subset of the plurality of weight batch orders to the first supply batch of food items by determining which weight batch order best corresponds with the estimated weight data; and scheduling fulfilment of the determined best corresponding weight batch order.

### FIELD OF THE INVENTION

The present invention relates to a method for processing and batching food items, in particular, for processing and batching poultry, fish or meat whilst reducing giveaway and improving throughput of order fulfilment.

### BACKGROUND OF THE INVENTION

Food processing lines that prepare and batch food items such as poultry, fish or meat typically batch poultry according to at least one target criteria including at least one weight target.

Often, when creating batches having pre-defined weight targets of fixed number of food items it results in overweight. In general, because a fixed number of items in a pack is often requested the pack weight can only be equal to the average weight of the items to be packed multiplied by the number of items in the pack.

WO2016/113428 provides an improved food processing line that maximises the yield when generating batches fulfilling at least one target, including a weight target, where the target may also include a fixed number target for the food items in the batches. Maximising yield minimises giveaway of food items when producing batch sizes. Giveaway in this context refers to food items, such as poultry that is packaged overweight. According to WO2016/113428 the optimisation of matching of food items in the processing system to the received orders using a prospect indicator increases the yield of the batching process due to little overweight that results from the batching process. Thus, by measuring the weight of several food items during batching according to WO2016/113428, it is possible to determine a prospect indicator so that the decision of whether or not to trim or cut a specific food item can be taken on the basis of a more general or dynamic evaluation.

As an example, a situation that often occurs is that food orders, eg. flocks of poultry or other food items come in at lots of different times during the day from lots of different farms. Scheduled deliveries for fulfilment may arrive late at a processing site due to traffic problems or delays at the farm. At the same time, orders from consumers such as supermarkets, food stores and consumers can arrive on-line at any time, 24 hours a day, 7 days a week. Orders for fulfilment may be cancelled at short notice or orders may be increased or modified in some way, perhaps minutes prior to scheduled fulfilment.

Accordingly, a prior art method of determining which of the plurality of received orders best corresponds to the food items during batching may struggle to adapt in real-time to the changing inputs of deliveries and orders whilst seeking to minimise giveaway.

### SUMMARY OF THE INVENTION

Accordingly, what is needed in the art is a method and apparatus for processing and batching food items that can react more quickly, ideally in real-time to changing input and output parameters whilst minimising giveaway of food product when producing batch sizes.

To better address one or more of these needs, in an aspect of the present invention there is provided a method of fulfilling a plurality of weight batch orders in a food item processing line, the method comprising: obtaining an estimated weight data of a first supply batch of food items; receiving a plurality of weight batch orders; allocating a subset of the plurality of weight batch orders to the first supply batch of food items by determining which weight batch order best corresponds with the estimated weight data; and scheduling fulfilment of the determined best corresponding weight batch order.

In an aspect of the present invention there is provided a method of fulfilling a plurality of weight batch orders in a food item processing line, the method comprising: obtaining an estimated weight data of a first supply batch of food items; receiving a plurality of weight batch orders; allocating two or more of the plurality of weight batch orders to the first supply batch of food items by determining which weight batch orders best correspond with the estimated weight data; and scheduling fulfilment of the determined best corresponding weight batch orders.

Typically, a weight batch order is a fixed weight batch order. This means that the weight batch order is for a number of food items, or whole food items, having a fixed weight (within an agreed tolerance). Such a customer may, for example, order a thousand 200 g poultry fillets to be ultimately packaged into groups of 4 fillets of 0.8 kg per tray. In other embodiments, a customer may require a batch order comprising a fixed number of fillets, where the number of fillets is more important to the customer than their individual weights. The provided fillets may fall in range of 200-225 g and so the weight of the batch order is not fixed by the request, but only fixed once the batch order is fulfilled.

Therefore, estimated weight data is attributed to a supply batch of food items such as to a flock, before the food items or flock is weighed on arrival at a processing line. By allocating a subset of orders to the estimated weight prior to arrival, the allocation process is improved through time saving. As more orders are received, changed, or allocated and as more weight data is received from scheduled flock deliveries, the allocation of orders can change right up to the point of cutting and packaging.

Many of the stages associated with gathering and transport of the flock can be associated with data collection and monitoring through embedded devices in what is commonly known as the Internet of Things (IoT). In an environment with these IoT devices measuring and collecting data about their surroundings, there is an abundance of data which is available for processing by analytical systems enriched with artificial intelligence, machine learning and analytical discovery techniques to produce valuable insights, provided that the data can be appropriately consumed and prepared for the application of analytical tools.

Such data can be weight data estimated from historical measured weight data records or weight data estimated based on a measurement of say, number of birds loaded into transport as measured by an IoT device or determined by a user.

The historical weight data can be a weight of an individual food item such as a poultry bird or in the case of meat, the weight of an entire pig or in the case of fish an entire salmon although the person skilled in the art will appreciate that many whole food items can be used.

The historical measured weight data can be weight data from previously slaughtered food items on a batching line, such as previously slaughtered poultry, fish, or meat items. The weight data can be stored from any historical batching line and used for estimating the weight data predicted for a batch on any batching line.

Further data such as to the temperature of the transport, the distance travelled, the health of the food item and chemicals in the immediate environment may also be measured and consumed by IoT devices during the lifetime and transport of the food item.

Preferably the method includes tagging one or more measurable parameters to the first supply batch of food items and wherein each weight batch order has an associated fulfilment characteristic. Allocating a subset of the plurality of weight batch orders to the first supply batch of food items therefore may include determining which weight batch order or orders best corresponds with the estimated weight data and which fulfilment characteristic or characteristics best corresponds to the one or more measurable parameters. Preferably, the method includes updating the tagged one or more measurable parameters of the first supply batch of food items based upon a visual inspection and further preferably weighing a number of the individual food items of the first supply batch of food items to obtain measured weight data.

In embodiments, the food items are poultry, and the measurable parameters are one or more of size of bird, organic, free range, caged, halal, number of blood spots, physical abnormalities, breed of bird, originating farm, number of birds, average weight of birds. Many of these measurable parameters may be made from IoT devices or input into remote devices such as laptops, tablets, such as iPads®, or smartphones at the farm and appropriately digested.

In embodiments, the food items are poultry, and the fulfilment characteristics are one or more of priority of order, weight limit, pallet size, price, expiry date, organic, free range, caged, halal, number of blood spots, physical abnormalities, breed of bird, originating farm, whole poultry birds, poultry drumstick, poultry wings, poultry breast fillets. Many of these measurable parameters may be made from IoT devices or input into remote devices such as iPads® or smartphones at the farm and appropriately digested.

In operation, a system may have the step of verifying the allocation of the subset of the plurality of weight batch orders to the first supply batch of food items by determining which weight batch order or orders best corresponds with the measured weight data, which may further include verifying the allocation of the subset of the plurality of weight batch orders to the first supply batch of food items by determining which weight batch order or orders best corresponds with the measured weight data and which fulfilment characteristic or characteristics best corresponds to the updated one or more measurable parameters of the first supply batch of food items based upon the visual inspection.

Such measured weight data may require re-allocating a subset of the plurality of weight batch orders to the first supply batch of food items and/or re-scheduling fulfilment of the determined best corresponding weight batch order or orders to a second supply batch of food items.

In certain embodiments, the food items comprise poultry and scheduling fulfilment of the determined best corresponding weight batch order or orders includes allocating whole poultry birds to at least a first and a second batching area. In the case of poultry, the first batching area may include a breakup line for breaking up a whole poultry bird into poultry items and the second batching area includes a batching line for processing whole poultry birds.

Preferably, the food item is poultry, and the poultry is slaughtered poultry items carried by a conveyor.

Preferably, the food item is poultry, and the poultry is slaughtered poultry items carried by carriers attached and conveyed by an overhang rail system.

The method may include automatically adjusting the allocation of the poultry from the overhang rails system to two or more batching areas when new order data indicating new different weight targets is received or further comprising bypassing the poultry from the two or more batching areas if resulting smaller poultry pieces do not fulfil a pre-defined weight target data criterion.

In embodiments, at least one weighing device is integrated into the overhang rail system and where the weight of individual poultry items is determined while the poultry items are conveyed.

In embodiments, the at least one of the plurality of weight batch orders includes a whole poultry bird and/or at least one of the plurality of weight batch orders is for a portion of a poultry bird and the fulfilment characteristic includes a number of individual poultry bird portions making up the weight of the order.

Where a handling device is used at least one handling device may have at least one robotic device, and wherein transferring food items to multiple batching areas comprises picking up the food items and placing them at the multiple of batching areas. Many handling devices are known, and a preferred handling device comprises multiple of sweep arms placed along the conveyor device, and where transferring the food items to a multiple of batching areas is performed via opening and closing the multiple of sweep arms. A control unit may control the at least one handling device. The method may include at least one tray feeding device for feeding empty trays acting as batching areas, wherein the trays are advanced by an advancing device continuously or in discrete steps relative a conveyor device while the generation of the batches takes place.

Where poultry is used, the method may include updating the estimated weight data of subsequent supply batches of poultry based upon historical measured weights and/or include updating the tagging of one or more measurable parameters based on historical visually inspected measurable parameters.

Such updating can be performed by an artificial intelligence module employing a machine learning algorithm.

Preferably, the weight data is an average, medium or mode weight of first supply batch of food items, optionally wherein the food items are poultry. In the case of the estimated weight data, a total weight or a number of food items is estimated, or both is estimated, optionally wherein the food items are poultry. Optionally, the weight data is a weight distribution of the first supply batch of food items, optionally wherein the food items are poultry. The weight distribution can be modelled to fit a Gaussian distribution of weight versus frequency and/or the weight data is a list of weight of food items stored in a look up table for a given number of food items, optionally wherein the food items are poultry.

In embodiments, when the food items are a whole poultry bird then the weight data is the weight of smaller poultry pieces. In alternative embodiments, a food item may be a whole fish and the weight data may be fillets or tails; where the food item is meat the weight data may relate to a leg or shoulder of lamb for example, or a ham of a pig.

In embodiments, the method includes a fulfilment indicator and a reference value attributed to the weight data, wherein best corresponds occurs when the reference value meets or is within a threshold from the fulfilment indicator. Additionally, the threshold may differ for individual fulfilment characteristics and measurement parameters. For example, when a food item is broken into a smaller poultry piece, for example a weight of a leg, the threshold of acceptable weight may have a different range to the weight range of a white fish fillet because a few grammes may not make a difference to a batch of chicken legs but will make a difference to white fish fillet, which cannot be sold underweight. Also, if a measurement parameter is organic then there is no range, because it is either organic or it is not organic. Physical abnormalities may also have a range.

Preferably, the method includes verifying the allocation of the subset of the plurality of weight batch orders to the first supply batch of poultry by determining which weight batch order and fulfilment characteristic best corresponds with the measured weight data and the one or more measurable parameters.

### BRIEF DESCRIPTION OF THE DRAWINGS

Embodiments of the invention will now be described, by way of example only, with reference to the accompanying drawings, of which:

FIG. 1 is a schematic diagram of individual prepared poultry on an overhead rail according to an embodiment of the invention;

FIG. 2 is a flow chart of the overall planning and execution of the method of processing and batching food items according to an embodiment of the invention;

FIG. 3 is a flow chart of method start-up parameters according to an embodiment of the invention;

FIG. 4 is a flow chart of main execution of the method of embodiments of the invention;

FIG. 5 is a schematic diagram of input of weight data being fulfilled into allocated orders according to an embodiment of the invention;

FIG. 6 is a schematic diagram of weight distribution for poultry according to some fulfilment criteria based on weight according to an embodiment of the invention; and

FIG. 7 is a schematic diagram of a top view of part of an embodiment of a poultry processing system according to an embodiment of the invention.

### DETAILED DESCRIPTION OF VARIOUS EMBODIMENTS

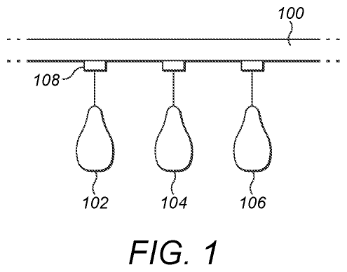

Referring to FIG. 1, a schematic diagram of individual prepared poultry 102, 104, 106 hung by shackles 108 on an overhead rail 100 according to an embodiment of the invention are ready for processing. An objective of the method and apparatus for processing and batching food items according to the present invention is to determine the best processing of the poultry to meet orders, in particular to minimise giveaway of food product when producing batch sizes. For example, poultry 102 may have an ideal weight and appearance to match a whole bird medium order, whereas poultry 104 may have an ideal drum weight to match an order for packs of chicken drums; poultry 106 an ideal weight match for wings plus a weight matching an order for chicken breast.

It is well known that each portion of a prepared bird, such as breast, thigh and wing comprise a percentage of the overall weight of the bird. Such that when a weight of a bird is estimated or measured then the weight of the portion can be easily determined. Further, there is typically little variance in these percentages from bird to bird. For example, two drumsticks may account for 13% to 15% of a bird weight; a breast cap may account for up to 34% to 36% of the overall bird weight. Similar known percentages exist for live feathered birds, since the prepared bird is itself a percentage of the live weight.

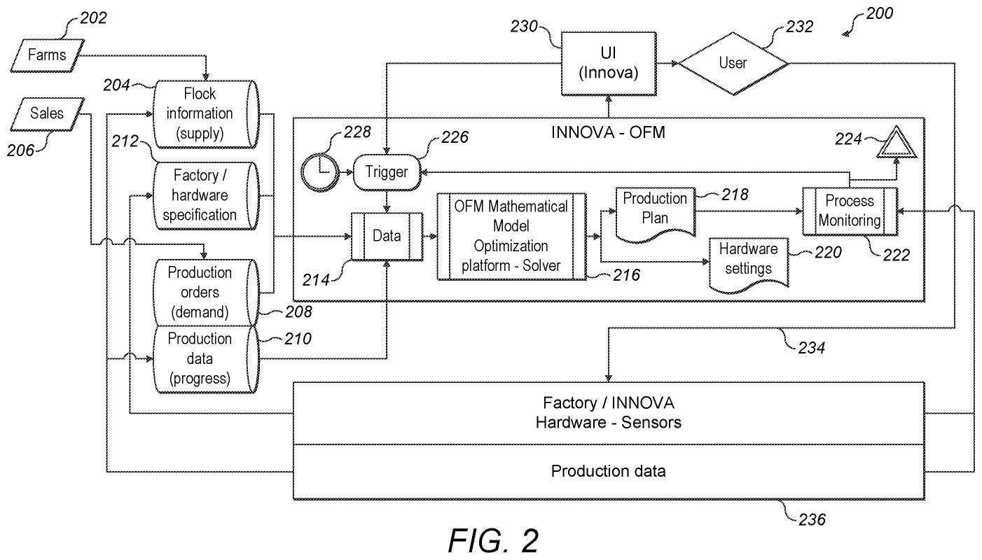

Referring to FIG. 2, a flow chart of the overall planning and execution 200 of the method of processing and batching food items according to an embodiment of the invention comprises various components to enable the efficient implementation of the present invention. Farms 202 provide data according to the flock 204 which is aggregated to a data stream of sales 206 having inputs of a demand for production orders 208 and a progress of production data 210. A processing factory has a data input of its hardware specification 212 attributable to the type of factory, capacity and capability. The data inputs from the farms 202, flock 204 and sales 206 are input to a data digest 214 for suitable consumption of the data, which can involve various optimised algorithms 216 for output as a production plan 218. A feedback to hardware settings 220 can be implemented due to learning arising from the algorithms 216, which can make adjustments to the factory hardware specification 212. Process monitoring 222 is carried out of the production plan 218 for further refinement and may generated a warning 224 and the process monitoring 222 may implement a trigger 226 to initiate the process, in turn controlled by scheduling module 228. Further input into the trigger 226 is carried out by a user interface normally under the control of a human operative 232. The human operative 232 can authorise the feedback 234 to hardware settings 220 implemented due to learning arising from the algorithms 216, which can make adjustments to the factory hardware specification 212. Production data 236 has an input to processing monitoring 222 and to the flock data 204.

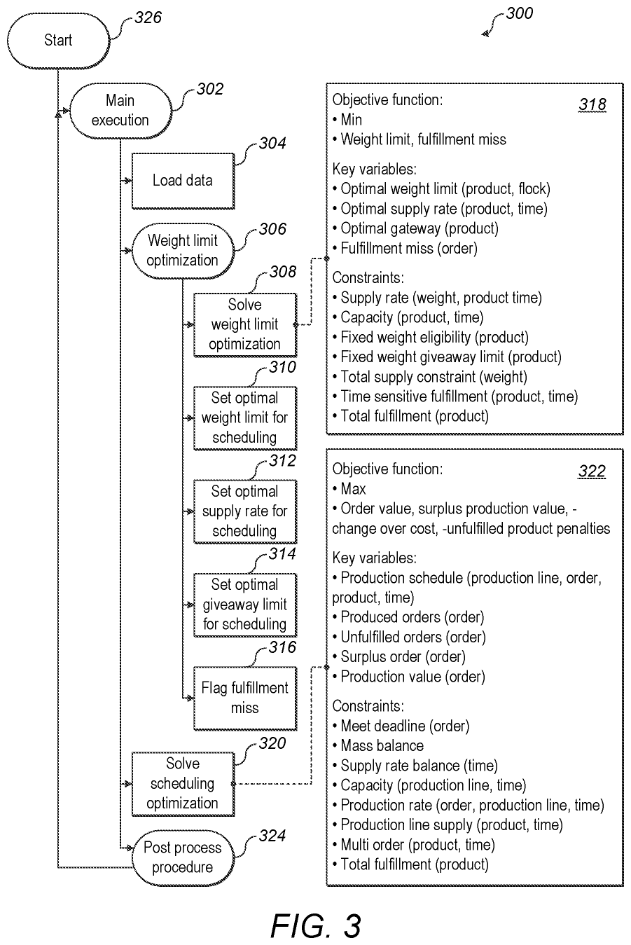

Referring to FIG. 3, a flow chart of method start-up parameters 300 according to an embodiment of the invention comprises a main execution step 302 which loads data obtained from the various data sources described in more detail in connection with FIG. 2. Various parameters are determined for weight limit optimisation 306 to be fulfilled including solving weight limit optimisation 308, setting optimal weight limit for scheduling 310, setting optimal supply rate for scheduling 312, setting optimal giveaway limit for scheduling 314 and flagging any fulfilment miss 316. Parameters for solving weight limit optimization 308 are listed in module 318 and parameters for solving scheduling optimization 320 are listed in module 322. A post process procedure 324 may be used to adjust the start 326 and main execution step 302.

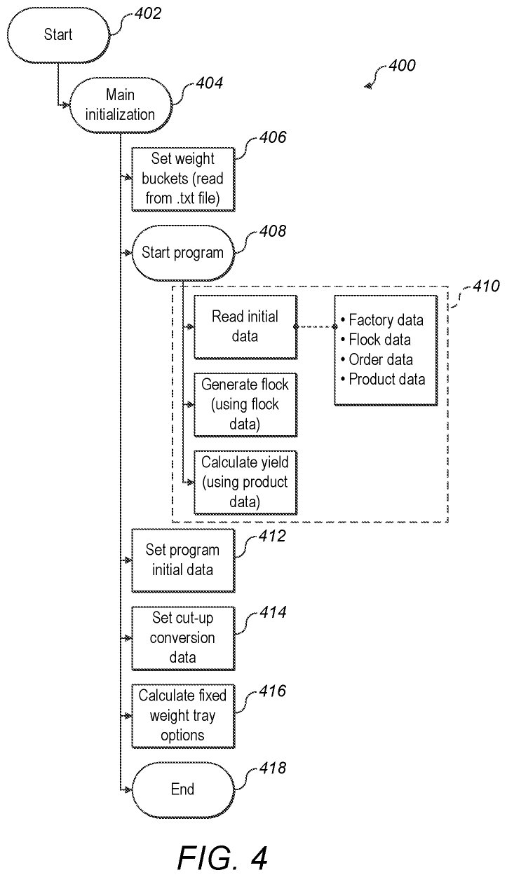

Referring to FIG. 4, a flow chart of main execution 400 of the method of embodiments of the invention comprises after start 402 and main execution 404 a number of so-called weight buckets 406 are defined for the incoming flock and batch orders. Once the program is started 408 the data can be read 410 in order to generate flock using flock data and calculate yield using product data. Once determined, the program is set 412, the data converted 414 and fixed weight tray options calculated 416 until the program ends 418.

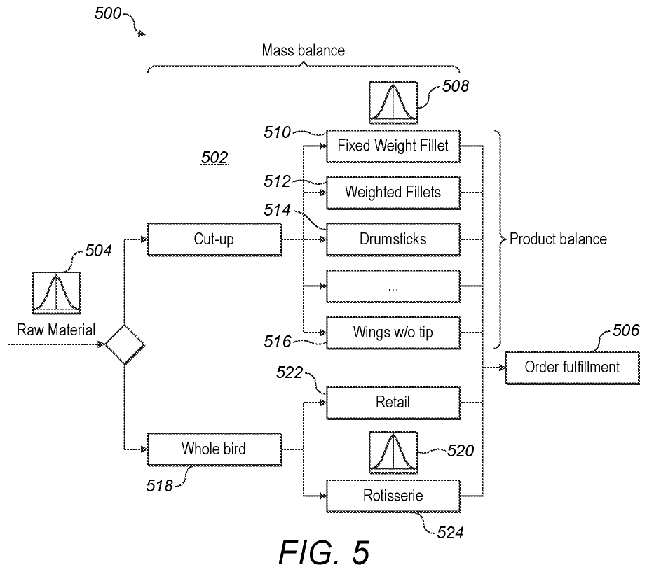

Referring to FIG. 5, a schematic diagram of input of weight data 500 being fulfilled into allocated orders according to an embodiment of the invention comprises determination of a mass balance 502 of the food products for example poultry. Raw material is input and will have a weight distribution rather like a Gaussian distribution of weight 504 centred around a mean value. In order to generate order fulfilment 506 according to present techniques, a poultry bird is cut up according to a fulfilment distribution 508 by, for example, a fixed weight fillet 510, weighted fillets 512, drumsticks 514 and including but not limited to wings 516. Where there is a better fit to the weight distribution and where an order specifies a whole bird 518 then a whole bird 518 may fit a whole bird distribution 520 for shelf sale 522 or rotisserie i.e. cooked sale 524. In this way, food items may be selected or ranked for fulfilment of an order in differing orders of priority.

Ranking orders for fulfilment may be a dynamic feature rather than a static feature. In present techniques, the relative ranking of orders for fulfilment may change depending on the metrics specified as important by the application or user. Such a technique is beneficial to the flexibility of the service since different applications or users can have different technical requirements for their service selected from fulfilment characteristics, measurement parameters or a mixture of both. These include size of bird, organic, free range, caged, halal, number of blood spots, physical abnormalities, breed of bird, originating farm, number of birds, average weight of birds, as age of data, update frequency, volume and so in this way ranking is context specific.

Additional flexibility can be introduced into the service as raw factors and ranking data is supplied to the application or user to allow them to apply their own processing and algorithms to make their own determinations about the value and quality of the device data that is received.

In any data ranking system, a subset of data sources may become more trusted than other sources. Such more trusted sources of data may result in a tiered, hierarchical ordering of data which in turn may lead to the provision of a “data division” per category of data. Such an ordering of data can enable a user to immediately access most relevant data for its purpose. Other embodiments for data self-enrichment include data criticality such as a measure of how important some fulfilment characteristics or measurable parameters are to a consumer. For example, organic meat may be allocated a 1 or 0, in that all meat is rejected that is not certified organic. It may be different for other factors such as age of bird, which may be allowed more tolerance and a spread of acceptable ages. Such improvement may provide a self-review or other automated review and ranking framework for the data.

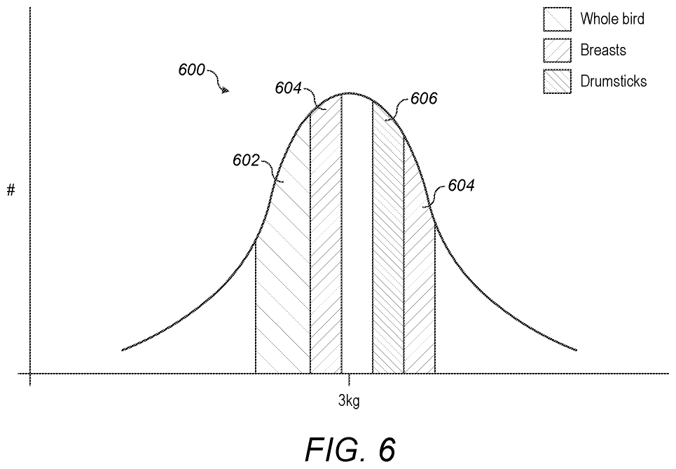

Referring to FIG. 6, a schematic diagram of weight distribution 600 for poultry according to some fulfilment criteria based on weight according to an embodiment of the invention comprises an average weight of 3 kg with whole birds 602 being selected over a range of weight distribution, breast meat 604 and drum sticks 606 also selected from the distribution.

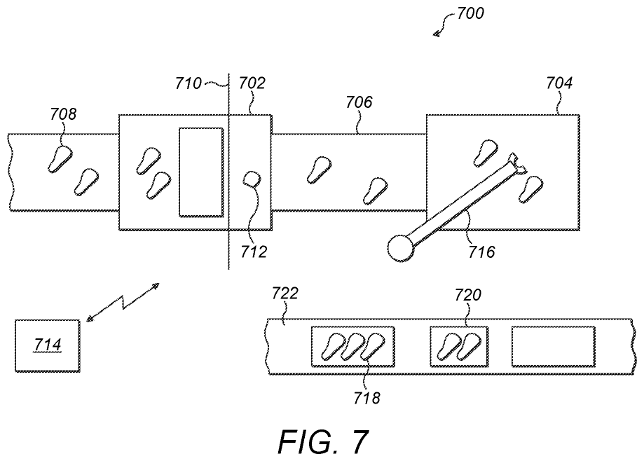

FIG. 7 is a schematic diagram of a top view of part of an embodiment of a poultry processing system 700 according to an embodiment of the invention. Illustrated is a food separation device 702, a batching system 704 and a conveyor means 706 which transports incoming food items 708 to the food separation device 702 and the batching system 704.

The food item separation device 702 may comprise a cutting device 710 arranged to cut incoming food items 708 into cut food items 712 according to instructions received from a control system 714. The cutting device 710 may be embodied by a cutting means e.g. a knife, connected to a robot arm, or other controllable device, capable of cutting means to particular food items 708 to be cut.

The batching system 704 may comprise at least one controllable handling means 716, e.g. embodied by one or more robot arms, capable of transferring particular food items 712 from the conveyor means 706 to batches 718, 720. The batches 718, 720 may be of the same type or of different types e.g. different types for accommodating different numbers of food items 712 and or different weights of food items in the batches. It is understood that different types of batches 718, 720 may in fact be structurally identical, but intended for accommodating different numbers of food items 708. For example, batches 720 may be used for 400 g batch jobs, where each batch should contain two items with a total weight of at least 400 g. Batches 718 may similarly be used for 400 g batch jobs, where each batch should contain three items with a total weight of at least 400 g. The batches 718 and 720 may be transported on a batch conveyor 722.

In operation, a whole poultry bird may undergo a breakup process into different batching lines such that the whole poultry bird can undergo more than one breakup process onto different processing lines. For example, poultry fillets can be placed on one batching line, and the poultry pieces such as wings and/or legs go to another batching line. It may be considered by a user that the weight distribution of the batching line for the wings is not as important as the weight distribution for the fillets.

Any weight distribution can be selected as appropriate for any particular food item. For example, a target weight distribution will depend on the orders received (weight target and e.g. number of pieces in the trays), where in case of a more “difficult” batch, such as only 3 fillets in a tray with a target weight, that the requirement might be that the distribution is narrower than if a batch was made to fulfil an order of for example 6 fillets in a tray, where a broader weight range may be acceptable i.e. more tolerance is provided in the weight rang. In practical terms, embodiments include adapting the weight distribution to the batches currently taking place, and when an order from customer A is completed, and a new order is received with “easier” batches (e.g. larger weight and larger number of pieces), that the distribution requirements can then be automatically adjusted and new weight range defined.

1.-36. (canceled)

37. A method of fulfilling a plurality of weight batch orders in a food item processing line, the method comprising:
obtaining an estimated weight data of a first supply batch of food items;
receiving a plurality of weight batch orders;
allocating a subset of the plurality of weight batch orders to the first supply batch of food items by determining which weight batch order best corresponds with the estimated weight data; and
scheduling fulfilment of the determined best corresponding weight batch order.

38. The method according to claim 38, including tagging one or more measurable parameters to the first supply batch of food items and wherein each weight batch order has an associated fulfilment characteristic.

39. The method according to claim 38, wherein allocating a subset of the plurality of weight batch orders to the first supply batch of food items includes determining which weight batch order best corresponds with the estimated weight data and which fulfilment characteristic best corresponds to the one or more measurable parameters.

40. The method according to claim 38, including updating the tagged one or more measurable parameters of the first supply batch of food items based upon a visual inspection.

41. The method according to claim 37, including weighing a number of the individual food items of the first supply batch of food items to obtain measured weight data.

42. The method according to claim 41, including:
verifying the allocation of the subset of the plurality of weight batch orders to the first supply batch of food items by determining which weight batch order best corresponds with the measured weight data.

43. The method according to claim 41, including:
verifying the allocation of the subset of the plurality of weight batch orders to the first supply batch of food items by determining which weight batch order best corresponds with the measured weight data and which fulfilment characteristic best corresponds to the updated one or more measurable parameters of the first supply batch of food items based upon the visual inspection.

44. The method according to claim 42, including:
re-allocating a subset of the plurality of weight batch orders to the first supply batch of food items and/or re-scheduling fulfilment of the determined best corresponding weight batch order to a second supply batch of food items.

45. The method according to claim 37, wherein the food items comprise poultry and scheduling fulfilment of the determined best corresponding weight batch order includes allocating whole poultry birds to at least a first and a second batching area.

46. The method according to claim 45, wherein the first batching area includes a breakup line for breaking up a whole poultry bird into poultry items and the second batching area includes a batching line for processing whole poultry birds.

47. The method according to claim 37, wherein the food item is poultry and the poultry is slaughtered poultry items carried by a conveyor.

48. The method according to claim 37, wherein the food item is poultry and the poultry is slaughtered poultry items carried by carriers attached and conveyed by an overhang rail system.

49. The method according to claim 48, further comprising automatically adjusting the allocation of the poultry from the overhang rails system to two or more batching areas when new order data indicating new different weight targets is received.

50. The method according to claim 46, further comprising bypassing the poultry from the two or more batching areas if resulting smaller poultry pieces do not fulfil a pre-defined weight target data criterion.

51. The method according to claim 48, wherein at least one weighing device is integrated into the overhang rail system and where the weight of individual poultry items is determined while the poultry items are conveyed.

52. The method according to claim 37, wherein the food items are poultry and the measurable parameters are one or more of size of bird, organic, free range, caged, halal, number of blood spots, physical abnormalities, breed of bird, originating farm, number of birds, average weight of birds.

53. The method according to claim 37, wherein the food items are poultry and the fulfilment characteristics are one or more of priority of order, weight limit, pallet size, price, expiry date, organic, free range, caged, halal, number of blood spots, physical abnormalities, breed of bird, originating farm, whole poultry birds, poultry drum stick, poultry wings, poultry breast fillets.

54. The method according to claim 37, wherein at least one of the plurality of weight batch orders includes a whole poultry bird.

55. The method according to claim 37, wherein at least one of the plurality of weight batch orders is for a portion of a poultry bird and the fulfilment characteristic includes a number of individual poultry bird portions making up the weight of the order.

56. The method according to claim 37, including at least one handling device having at least one robotic device, and
wherein transferring food items to multiple batching areas comprises picking up the food items and placing them at the multiple of batching areas.

57. The method according to claim 56, wherein the at least one handling device comprises multiple of sweep arms placed along the conveyor device, and where transferring the food items to a multiple of batching areas is performed via opening and closing the multiple of sweep arms.

58. The method according to claim 56, wherein a control unit controls the at least one handling device.

59. The method according to claim 37, further comprising at least one tray feeding device for feeding empty trays acting as batching areas,
wherein the trays are advanced by an advancing device continuously or in discrete steps relative a conveyor device while the generation of the batches takes place.

60. The method according to claim 37, including updating the estimated weight data of subsequent supply batches of poultry based upon historical measured weights.

61. The method according to claim 40, including updating the tagging of one or more measurable parameters based on historical visually inspected measurable parameters.

62. The method according to claim 60, wherein the updating is performed by an artificial intelligence module employing a machine learning algorithm.

63. The method according to claim 37, wherein the weight data is an average, medium or mode weight of first supply batch of food items.

64. The method according to claim 37, wherein in the case of the estimated weight data, a total weight or a number of food items is estimated, or both is estimated.

65. The method according to claim 37, wherein the weight data is a weight distribution of the first supply batch of food items.

66. The method according to claim 65, wherein the weight distribution is modelled to fit a Gaussian distribution of weight versus frequency.

67. The method according to claim 37, wherein the weight data is a list of weight of food items stored in a look up table for a given number of food items.

68. The method according to claim 37, including a fulfilment indicator and a reference value attributed to the weight data,
wherein best corresponds occurs when the reference value meets or is within a threshold from the fulfilment indicator.

69. The method according to claim 68, wherein the threshold differs for individual fulfilment characteristics and measurement parameters.

70. The method according to claim 37, wherein the weight batch order is a fixed weight batch order.

71. The method according to claim 37, wherein the subset of the plurality of weight batch orders comprises two or more weight batch orders.

72. The method according to claim 71, wherein the allocation of the subset of the plurality of weight batch orders to the first supply batch of food items comprises determining which weight batch orders best correspond with the estimated weight data, the method further comprising scheduling fulfilment of the determined best corresponding weight batch orders.
